(19) United States
(12) Patent Application Publication
(10) Pub. No.: US 2026/0080530 A1
(43) Pub. Date: Mar. 19, 2026

(54) GUI FOR DISPLAYING A PLURALITY OF MOBILITY MEASUREMENTS

(71) Applicant: AUDIOPTICS MEDICAL INC., Halifax (CA)

(72) Inventors: Dan MACDOUGALL, Halifax (CA); Rob ADAMSON, Halifax (CA)

(21) Appl. No.: 18/887,113

(22) Filed: Sep. 17, 2024

(51) Int. Cl. G06T 7/00; G06F 3/0481

(52) U.S. Cl. CPC G06T 7/0012; G06F 3/0481; G06T 2207/10101

(57) ABSTRACT

Disclosed herein are system, apparatus, article of manufacture, method and/or computer program product embodiments, and/or combinations and sub-combinations thereof, for a computer-implemented method for displaying a plurality of measurement cycles at a plurality of frequencies in a graphical user interface (GUI) including generating a first image including a structure based on at least one signal, wherein the at least one signal includes a vibrometry measurement of a vibration of the structure, displaying a first window within the GUI including the first image, generating a second image including a real time image of the structure, displaying a second window within the GUI including the second image, determining a plurality of mobility measurements at the plurality of frequencies for at least one of the plurality of measurement cycles, wherein each of the plurality of the mobility measurements are based on an amplitude of the vibration induced at the structure and sound pressure driving the vibration of the structure at each of the plurality of frequencies, displaying a third window within the GUI including a plot of at least of the plurality of mobility measurements at the plurality of frequencies, and updating the plot based on sound pressure driving the vibration of the structure at a subsequent measurement cycle.

### TECHNICAL FIELD

The present disclosure is generally directed to a graphical user interface (GUI) displaying a plurality of mobility measurements at a plurality of frequencies via a plot.

### BACKGROUND

Different types of medical devices may conduct patient examinations including probing of the ear of the patient. The ear includes structures that transmit sound vibrations from the eardrum to the cochlea. Hearing loss may occur when the ear is unable to perform such actions.

One type of medical device for such ear probing may include an otoscope, which may be used to view and examine the ear canal of an ear by means of a light source and magnifying lens. An otoscope may provide only a two-dimensional view of the ear canal and its content. Other medical devices may include handheld otoscope vibrometry systems that may determine vibration amplitudes of structures within the ear and transmit images of such structures. Such handheld systems may include an acoustic system, an optical coherence tomography (OCT) system, and a camera system.

OCT in the handheld otoscope vibrometry systems allows for visualization of the structures in the ear based on measurements of motions measured by sensing phase differences of reflections of moving sample from the acoustic system. The measurements may be recorded at a plurality of frequencies.

When using the handheld otoscope vibrometry system, a user, such as a doctor, may perform measurements using the system. Images may be generated and displayed via a GUI. A GUI is known as a user interface that allows users to interact with electronic devices, such as a computer, through graphical icons or other visual indicators in order to view data collected. The GUI may display multiple windows, images, data, or symbols. Previous otoscopes may have depicted only an image, which is not sufficient for the user to determine problems or diseases based off measurements within the ear. Due to advancements of handheld otoscope vibrometry systems, more information is available to the user regarding the measurement and may be displayed to the user via the GUI.

Accordingly, a GUI displaying a plurality of mobility measurements at a plurality of frequencies via a plot is required.

### SUMMARY

Provided herein are system, apparatus, article of manufacture, method and/or combinations and sub-combinations thereof, for a GUI displaying a plurality of mobility measurements at a plurality of frequencies via a plot.

According to an aspect of the present disclosure, a computer-implemented method for displaying a plurality of measurement cycles at a plurality of frequencies in a graphical user interface (GUI) including generating a first image including a structure based on at least one signal, wherein the at least one signal includes a vibrometry measurement of a vibration of the structure, displaying a first window within the GUI including the first image, generating a second image including a real time image of the structure, displaying a second window within the GUI including the second image, determining a plurality of mobility measurements at the plurality of frequencies for at least one of the plurality of measurement cycles, wherein each of the plurality of the mobility measurements are based on an amplitude of the vibration induced at the structure and sound pressure driving the vibration of the structure at each of the plurality of frequencies, displaying a third window within the GUI including a plot of at least of the plurality of mobility measurements at the plurality of frequencies, and updating the plot based on sound pressure driving the vibration of the structure at a subsequent measurement cycle.

In some embodiments, the first image includes a region with vibration displacement amplitudes.

In some embodiments, the first image is a 2D, 3D, or 4D image.

In some embodiments, the region is designated by a graphic overlay in the first image.

In some embodiments, the first image is a B-mode image including a graphic overlay.

In some embodiments, the real time image is a camera image.

In some embodiments, the plurality of frequencies is emitted separately and are between 125 and 8000 Hz.

In some embodiments, the structure is an ossicle of the middle ear.

According to an aspect of the present disclosure, a system for displaying a plurality of measurement cycles at a plurality of frequencies in a graphical user interface (GUI) including one or more memories, and at least one processor each couple to at least one of the memories and configured to perform operations including generate a first image including a structure based on at least one signal, wherein the at least one signal includes a vibrometry measurement of a vibration of the structure, display a first window within the GUI including the first image, generate a second image including a real time image of the structure, display a second window within the GUI including the second image, determine a plurality of mobility measurements at the plurality of frequencies for at least one of the plurality of measurement cycles, wherein each of the plurality of the mobility measurements are based on an amplitude of the vibration induced at the structure and sound pressure driving the vibration of the structure at each of the plurality of frequencies, display a plot of at least of the plurality of mobility measurements at the plurality of frequencies, and update the plot based on sound pressure driving the vibration of the structure at a subsequent measurement cycle.

According to an aspect of the present disclosure, a non-transitory computer-readable medium having instructions stored thereon that, when executed by at least one computing device, cause the at least one computing device to perform operations including generating a first image including a structure based on at least one signal, wherein the at least one signal includes a vibrometry measurement of a vibration of the structure; displaying a first window within the GUI including the first image, generating a second image including a real time image of the structure, displaying a second window within a GUI including the second image, determining a plurality of mobility measurements at a plurality of frequencies for at least one of a plurality of measurement cycles, wherein each of the plurality of mobility measurement is based on an amplitude of the vibration of the structure and sound pressure driving the vibration induced at the structure at each of the plurality of frequencies, displaying a third window within the GUI including a plot of at least of the plurality of mobility measurements at the plurality of frequencies, and updating the plot based on sound pressure driving the vibration of the structure at a subsequent measurement cycle.

### BRIEF DESCRIPTION OF THE FIGURES

The accompanying drawings are incorporated herein and form a part of the specification.

FIG. 1 illustrates a system for displaying a plurality of mobility measurements at a plurality of frequencies, according to some embodiments.

FIG. 2 illustrates a GUI displaying a mobility measurement, an OCT image, and a camera image, according to some embodiments.

FIG. 3 illustrates a GUI displaying a conductive hearing loss assessment, according to some embodiments.

FIG. 4 illustrates a method for displaying a plurality of mobility measurements at a plurality of frequencies, according to some embodiments.

FIG. 5 illustrates an example computer system useful for implementing various embodiments, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or combinations and sub-combinations thereof, for a GUI displaying a plurality of mobility measurements at a plurality of frequencies via a plot.

Optical coherence tomography (OCT) is an optical interferometric imaging technology that may produce depth-resolved images of sub-surface tissue structures, such as structures within the ear. This may be accomplished by taking a spatially coherent infrared light-source and splitting it between a reference beam and a sample probing beam. Light that is backscattered from the structures within the sample is collected and interfered (combined) with the reference beam light in order to produce an interference pattern that, once processed, reveals the location of light-reflecting structures in the sample.

OCT has been applied to imaging the ear of patients. Anatomical structures within the ear may be imaged using OCT and may be used to perform functional imaging in the ear by measuring the vibration of middle ear structures in response to sound. Typically, the process may include using a handheld vibrometry system to extract magnitude of vibration information in non-real-time and OCT may rely on an acoustic stimulus that is applied to the ear; the acoustic frequency phase variations are then collected over many consecutive complete acoustic cycles and analyzed using Fourier analysis. The phase variations determined via the handheld vibrometry system may then be displayed to a user, such as a doctor or nurse. By displaying information to the user, the user may be guided by the displayed data to or how to proceed with the current procedure.

Such display options of phase variations may include a graphical user interface (GUI) on a display device, such as a computer. The GUI may display measurements, images collected, or information regarding the measurements. By utilizing the GUI, all information may be available to the user at the same time in the same location. Once measurements are displayed to the user, the user may be able to determine issues or diseases of the ear based on the measurements. The user may also determine whether or not a new measurement may be required based on various factors. For example, the patient may experience small movements during the measurement, making the measurements inaccurate. The patient's heartbeat or aspiration may also affect the measurement. Such movements may be reflected in the plot of the measurement, displayed via the GUI and may require a new measurement.

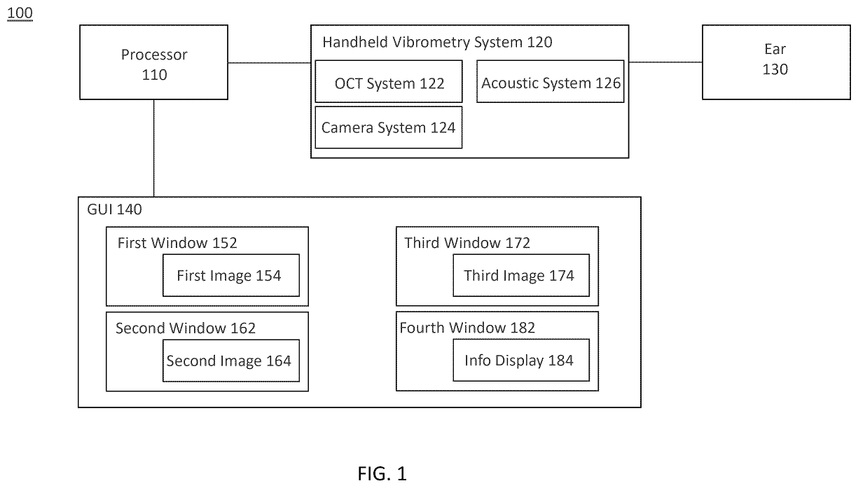

FIG. 1 illustrates a system 100 for displaying a plurality of mobility measurements at a plurality of frequencies, according to some embodiments. The system 100 may include a processor 110; a handheld vibrometry system 120 including an OCT system 122, a camera system 124, and an acoustic system 126; an ear 130; and a GUI 140 including a first window 152, a first image 154, a second window 162, a second image 164, a third window 172, and a third image 174. While only three windows 152 162 172 are depicted within the GUI 140, more or less windows may be envisioned. Similarly, while only three images 154 164 174 are depicted in the GUI 140, more or less images may be envisioned in the GUI 140. The images 154 164 174 may be 2D, 3D, or 4D image depending on what is being imaged.

While system 100 is described with respect to the ear 130, other body parts including soft tissue, may be examined as well. However, within the ear 130, structures such as the umbo, the ossicle, which includes the malleus, the incus, or the stapes of the middle ear, may be examined.

In some embodiments, a handheld vibrometry system 120 may be used to perform various measurements within the ear 130. The handheld vibrometry system 120 may include, for example, an acoustic system 126, an OCT system 122, and a camera system 124, but is not limited to such systems. The acoustic system 126 may generate an acoustic stimulus at a plurality of frequencies within the ear 130. Based on the plurality of frequencies, the acoustic system 126 may receive an acoustic pressure measurement. The frequencies of the acoustic stimulus may range between 125 and 8000 Hz and are emitted separately during a measurement cycle. For example, a first measurement cycle may start at 500 Hz, then proceed to 1000 Hz, 1550 Hz, and finally 1700 Hz. Data for each frequency is separately collected to be used later for processing.

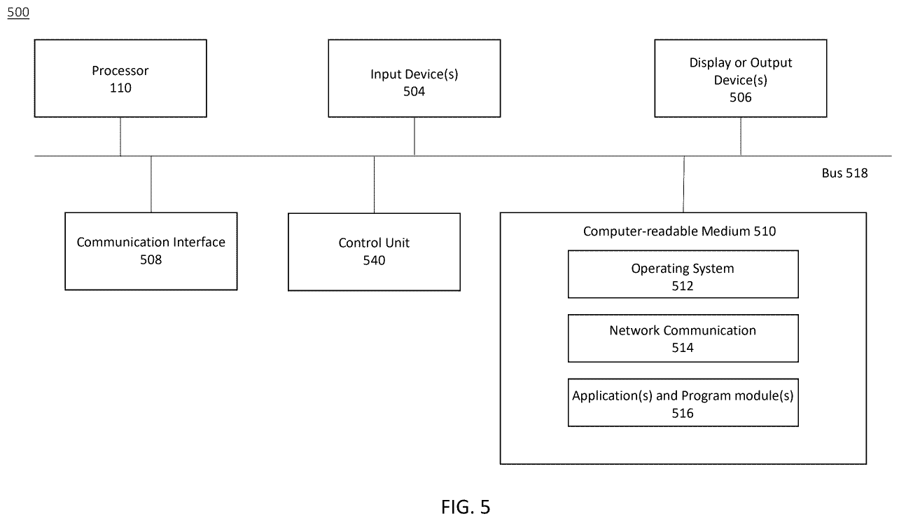

The OCT system 122 may include an OCT light source and an OCT sensor system, an interferometer configured to generate a sample beam and reference beam, and a detector to detect an interfered reference beam and scattered light, a scanning system for scanning the sample beam on the region of interest, such as the ear 130. Based on the acoustic stimulus generated, the OCT system 122 may receive signals and generate any of the first image 154, the second image 164, or the third image 174. Any of these images 154 164 174 may be displayed in a corresponding window 152 162 172 via the processor 110. The processor 110 is described in further detail in FIG. 5.

When using the OCT system 122 to generate the images 154 164 174, the images 154 164 174 may correspond to a B-mode image of the ear 130 and may include lines to indicate the depth selected for imaging. The B-mode image may be based on the acoustic stimulus generated from the acoustic system 126, a plurality of A-scans from the OCT system 122, and a plurality of sample interferograms.

Based on the frequency used during a measurement of the ear 130, a mobility measurement may be determined, via the processor 110. The mobility measurement may be based on an amplitude of the vibration of the structure from the acoustic system 126 and sound pressure driving the vibration of the structure in the ear 130 at the frequency. The mobility measurement may be measured multiple times at multiple frequencies thereby generating a plurality of mobility measurements.

In some embodiments, the plurality of mobility measurements may generate any of the first image 154, the second image 164, or the third image 174. Any of these images 154 164 174 may be displayed in a corresponding window 152 162 172 via the processor 110. In some embodiments, the image 154 164 174 may be a plot of the plurality of mobility measurements. The plot may be updated when new frequencies are measured, and new measurements are calculated based on the new frequencies.

The mobility measurement may be calculated at multiple structures within the ear 130, such as the umbo, malleus, the incus, or the stapes. These measurements may also be calculated for the left or the right ear 130 separately. Typically, at least one measurement, preferably up to four measurements, preferably more, should be collected at each region of interest within the ear 130 at a particular frequency. For example, for the left umbo of the ear 130, a measurement at 250Hz, 500 Hz, 1000 Hz, and 2000 Hz may be collected. Since four measurements are collected at each frequency, a total of at least 16 measurements may be collected. However, based on the patient, more or less measurements may be taken.

The number of measurements taken may be displayed in an info display 184 of a fourth window 182 of the GUI 140. Additionally, the info display 184 may include further details about the measurements taken, including but not limited to, what part of the ear 130 is being measured, what frequency is the measurement occurring at, what measurement number is being taken, or the like.

A camera system 124 may be used simultaneously with the OCT system 122. The camera system 124 may include a camera or image sensor and a light source. The camera system 124 may be a charged coupled device (CCD), complementary metal oxide semiconductor (CMOS) device, thermal, or infrared camera and may capture and record real-time images of structures within the ear 130. The camera system 124 may share a common beam path with the OCT system 122 such that the same region of interest is imaged within the ear 130.

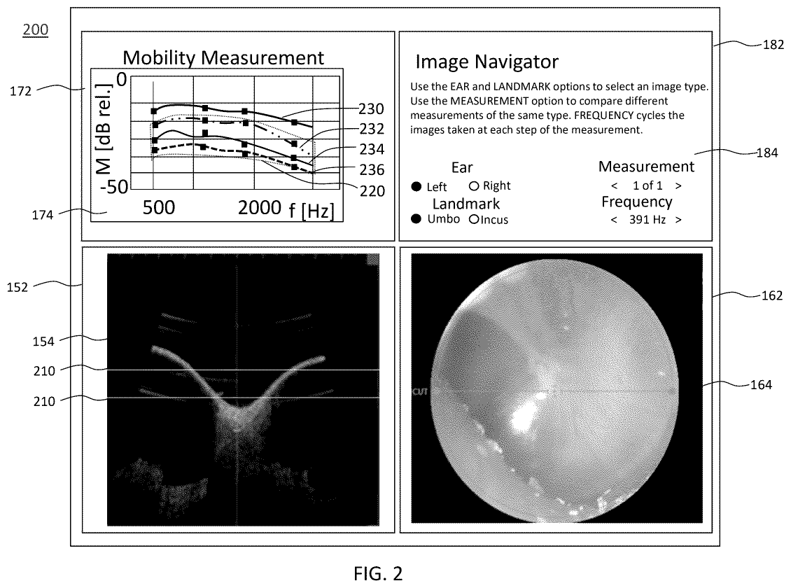

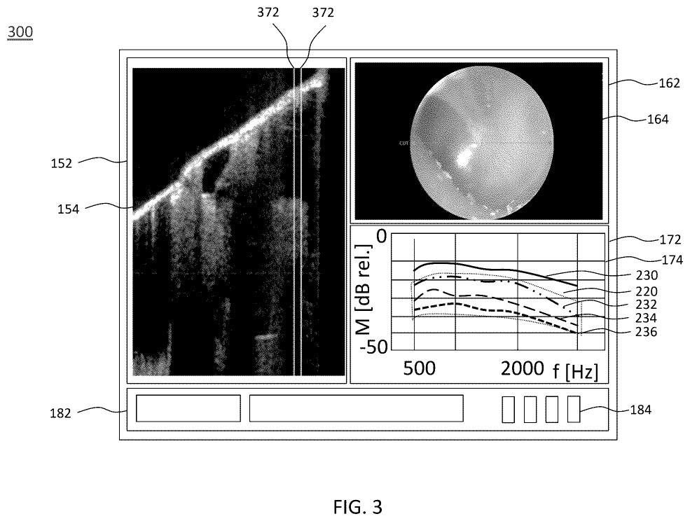

The camera system 124 may generate any of the first image 154, the second image 164, or the third image 174. Any of these images 154 164 174 may be displayed in a corresponding window 152 162 172 via the processor 110. In some embodiments, the image 154 164 174 may display the tympanic membrane, malleus, incus, stapes, or umbo of the patient. Such images may be further seen in FIGS. 2-3.

FIG. 2 illustrates a GUI 200 displaying a mobility measurement, an OCT image, and a camera image, according to some embodiments. The GUI 200 may include a first image 154 in a first window 152, a second image 164 in a second window 162, a third image 174 in a third window 172, and an info display 184 in a fourth window 182.

In some embodiments, a first image 154 may be an OCT image generated by the OCT system 122. The first image 154 may be displayed in the first window 152. The first image may include graphic overlays. For example, on the first image 154, depth lines 210 may overlay the OCT image, which may indicate the depth in the ear 130 at which the OCT image was produced. A second image 164 may be a real-time image generated by the camera system 124. The second image 164 may be displayed in the second window 162. A third image 174 may be a plot generated via the processor based on the measurement by the OCT system 122. The third image 174 may be displayed in the third window 172. The third image 174 may be generated once measurements of the ear 130 at various frequencies are completed by the OCT system 122. The third image 174 may include a plot of a plurality of mobility measurements at a plurality of frequencies via a plot. The fourth image 184 may be displayed in the fourth window 182. The fourth image 184 may include information about the measurement.

Depth lines 210 may be useful as an A-line includes phase information at each pixel along its full length, but at the structure in the ear 130 being measured, may be a subset of the pixels, typically in a tight grouping. Specifically, when measuring, a depth profile may be recorded once the reference arm of the OCT system 122 is scanned. This may then be referred to as the A-line. This may be repeated for each lateral scan. Image information in the axial direction along the A-line may be reconstructed from an interferometric measurement of delays of light, which may be backscattered or reflected the ear 130. This may be the first image 154. From the depth lines 210 in the first image 154, the user may determine that the measurement is occurring the correct position within the ear 130.

As depicted in FIG. 2, the third image 174 includes a plot of a plurality of mobility measurements at a plurality of frequencies. For example, four separate measurements may be taken, indicated by 230, 232, 234, and 236. The measurements have a plurality of frequency data points, ranging from 500 to 2500 Hz.

The data of the plurality of mobility measurements may include error bars, which indicate the accuracy level of the measurement, and may be calculated via the processor 110. Confidence bands and other suitable tools and measurements used in statistical analysis may be used to derive or represent information on uncertainties and/or estimations of the data. In addition, the plurality of mobility measurement may include the mobility of a normal hearing ear in comparison to the current ear 130 being measured. A normal hearing ear may be in the range, as indicated by region 220. A normal ear may vary based on a variety of factors including, but not limited to, sex, age, genetics, or the like. By comparing the mobility measurement of a normal hearing ear, indicated by region 220, versus the mobility measurement of the ear 130 being measured, indicated by 230, 232, 234, and 236, the user may determine whether or not patient's hearing may have issues. While only one region 220 is depicted in FIG. 3, more may be envisioned based on the patient's history or desired outcome of the measurement. The issues of the patient's hearing may be visualized thru the GUI 200. This allows for a user to address underlying ear health issues with data that may indicate hearing loss, fluid in the ear, or other hearing issues.

A normal hearing ear versus the ear 130 of the patient may vary based on a variety of factors such as age of the patient, sex of the patient, overall health of the patient, genetics, or the like. The range as indicated in region 220 may vary based on the factors described herein. Additionally, the mobility measurement displayed in the fourth window 182 may vary based on which structure of the ear 130 is being measured. Reference to the normal hearing ear may further include the patient's medical history previously measured versus current measurements or measurements of a normal hearing ear with the same factors, which may include sex, age, genetics, or the like.

More specifically, the patient may be attributed to a certain subgroup of the population, such as male, age 70-80. The measurements for this patient in this subgroup may be displayed in the context of a selected reference group in order to provide a meaningful result of the plot in the third image 174. The user may then learn based on the data that the patient's hearing is good or bad when compared to the average population of such a subgroup. This may include results that may be much less significant than the result or that their hearing is on average compared to the subgroup for reasons such as the patient being old compared to the average population. While this may be a limiting example, other examples of sex, age, and genetics may be envisioned.

In some embodiments, within the fourth window 182, information regarding the measurement may be display in the info display 184. The information may include, but is not limited to, which ear 130 is being measured, which structure within the ear 130 is being measured, which measurement number is being taken and at which frequency, or the like.

While images 154 164 174 correspond to systems within the handheld vibrometry system 120, the images may be displayed in any window 152 162 172 of the GUI 200. While windows 152 162 172 182 are displayed in a certain configuration within GUI 200, other configurations of the layout may be envisioned and the order of the windows 152 162 172 182 may be changed. For example, the first window 152 may be in the top right corner or any corner of the GUI 140 alternatively. Additionally, the images 154 164 174 may be 2D, 3D, or 4D, depending on which part of the handheld vibrometry system 120 has captured the image.

FIG. 3 illustrates a GUI 300 displaying a conductive hearing loss assessment, according to some embodiments. The GUI 300 may include a first image 154 in a first window 152, a second image 164 in a second window 162, a third image 174 in a third window 172, and an info display 184 in a fourth window 182.

In some embodiments, a first image 154 may be an OCT image generated by the OCT system 122. The first image 154 may be displayed in the first window 152. The first image may include graphic overlays. For example, on the first image 154, Doppler lines 372 may overlay the OCT image and may indicate a region with the vibration displacement amplitude information. The Doppler lines 372 may also indicate the depth selected for imaging. A second image 164 may be a real-time image generated by the camera system 124. The second image 164 may be displayed in the second window 162. A third image 174 may be a plot generated via the processor based on the measurement by the OCT system 122. The third image 174 may be displayed in the third window 172. The third image 174 may be generated once measurements of the ear 130 at various frequencies are completed by the OCT system 122. The third image 174 may include a plot of a plurality of mobility measurements at a plurality of frequencies via a plot. The fourth image 184 may be displayed in the fourth window 182. The fourth image 184 may include information about the measurement.

The fourth image 184 may include the same information as in FIG. 2, described herein. Specifically, measurements may be taken at 500 Hz, 700 Hz, 1000 Hz, 1350 Hz, 2000 Hz, and 3000 Hz and are indicated by solid line 230. Past measurements of the same ear are exemplarily and schematically shown as data points and lines as dashed-dot line 232, long dash line 234, and dashed line 236. Here the dashes may indicate a time ordering, for example the dashed-dot line 232 may correspond to the oldest measurement, long dash line 234 to the second oldest measurement, and dashed line 236 to the third oldest measurement before the current measurement, indicated by solid line 230. Instead of data points and lines, these measurements may also be shown with error bars or confidence bands and the like. Alternatively, or additionally, one or more of the data points and lines 232 234 236 may also correspond to the measurements of the same patient, but the other ear not currently measured. Alternatively, or additionally to type of line, any other property may be used to support the distinguishability of different measurements, for example shading, style, thickness and/or opacity, or the like. Similarly, the data points related to lines 232 234 236 need not to be measured at the same frequencies as the data points related to line 230.

Similarly, as FIG. 2, in FIG. 3 the range as indicated in region 220 may vary based on the factors described herein. Additionally, the mobility measurement displayed in the fourth window 182 may vary based on which structure of the ear 130 is being measured.

In some embodiments, within the fourth window 182, information regarding the measurement may be display in the info display 184. The information may include, but is not limited to, which ear 130 is being measured, which structure within the ear 130 is being measured, which measurement number is being taken, a progress meter of the measurement, a measurement at which frequency, a control panel, or the like. For example, the user may use the control panel, indicated by foot pedals, to take the next set of measurements.

Additionally, a foot panel (not pictured) may be connected to the processor 110 and the user may manually press the foot pedal to advance to the next measurement at the next frequency.

Additionally, the foot panel, a voice control unit, a gesture control unit and/or a gaze control unit (all not pictured) may be connected to the processor 110 and the user may manually press the foot pedal or input a respective command according to the respective control unit to advance to the next measurement. Alternatively, or additionally, a respective input option, like a button, is provided on the handheld vibrometry system 120 and connected to the processor 110 and the user may manually execute the input option, for example press the button, to advance to the next measurement.

While images 154 164 174 correspond to systems within the handheld vibrometry system 120, the images may be displayed in any window 152 162 172 of the GUI 200. While windows 152 162 172 182 are displayed in a certain configuration within GUI 200, other configurations of the layout may be envisioned and the order of the windows 152 162 172 182 may be changed. For example, the first window 152 may be on the right side of the GUI 140 alternatively.

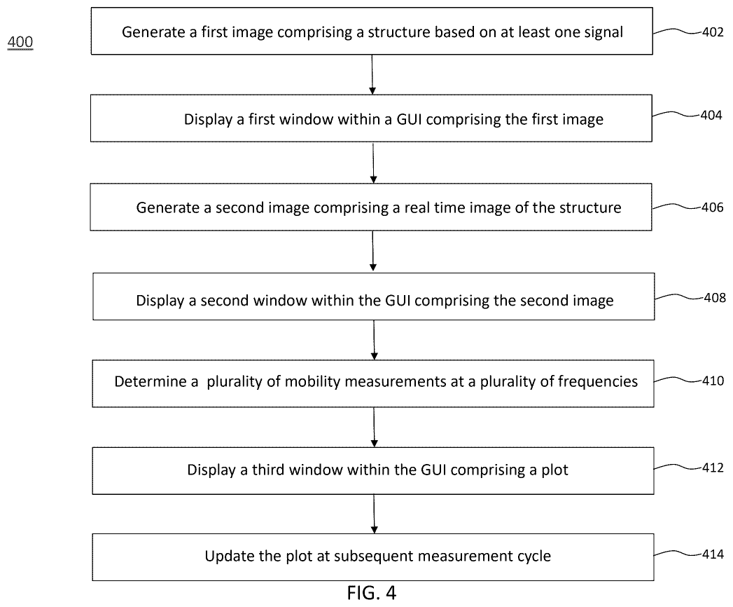

FIG. 4 is a flowchart for a method 400 for a GUI displaying a plurality of mobility measurements at a plurality of frequencies via a plot, according to an embodiment. Method 400 can be performed by processing logic that may include hardware (e.g., circuitry, dedicated logic, programmable logic, microcode, or the like.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3. However, method 400 is not limited to that example embodiment. The method 400 may include displaying a plurality of measurement cycles at a plurality of frequencies in a GUI.

In step 402, a first image may be generated via a processor including a structure based on at least one signal, wherein the at least one signal includes a vibrometry measurement of the vibration of the structure. The structure may be an ossicle of the middle ear. For example, a first image 154 may be generated via the processor 110. The first image 154 may include an image of a structure of the ear 130 based on a signal from the OCT system 122. The signal from the OCT system 122 may include a vibrometry measurement of the vibration of the structure of the ear 130.

In step 404, a first window may be displayed via the processor within the GUI including the first image. The first image may include a region with vibration displacement amplitudes and is designated by lines. The first image may be a B-mode image including depth selection indicators. For example, a first window 152 may be displayed via the processor 110 within the GUI 140. The first window 152 may include the first image 154, which may include the image of the structure of the ear 130 based on the signal from the OCT system 122. The first image 154 may include a region with vibration displacement and the region may include a graphic overlay in the first image, such as depth line indicators 210 or Doppler lines 372. Additionally, the first image may be a B-mode image including a graphic overlay, such as depth line indicators 210 or Doppler lines 372.

In step 406, a second image may be generated via the processor including a real time image of the structure. The real time image may be a camera image. For example, a second image 164 may be generated via the processor 110. The second image 164 may include a real time image of the structure based on an image generated from the camera system 124.

In step 408, a second window may be displayed via the processor within the GUI including the second image. For example, a second window 162 may be displayed via the processor 110 within the GUI 140. The second window 162 may include the second image 164, which may include the image of the structure of the ear 130 based on the image from the camera system 124.

In step 410, the plurality of mobility measurements may be determined via the processor at a plurality of frequencies for at least one of the plurality of measurement cycles, wherein each mobility measurement is based on an amplitude of the vibration induced at the structure and sound pressure driving the vibration of the structure at each of the plurality of frequencies. The plurality of frequencies may be emitted separately and may be between 125 and 8000 Hz. For example, the plurality of measurements may be determined via the processor 110 based on measurements by the OCT system 122 at a plurality of frequencies. Each mobility measurement may be based on the amplitude of the vibration of the structure within the ear 130 generated by the acoustic system 126 and sound pressure driving the vibration of the structure within the ear 130 at each of the plurality of frequencies, such as between 125 and 8000 Hz.

In step 412, a third window may be displayed via the processor within the GUI including a plot of at least of the plurality of mobility measurements at the plurality of frequencies. For example, a third window 172 may be displayed via the processor 110 within the GUI 140. The third window 172 may include the third image 174, which may include the plot of at least of the plurality of mobility measurements at the plurality of frequencies, as indicated by lines 220 232 234 236.

In step 414, the plot may be updated via the processor based on sound pressure driving the vibration of the structure at a subsequent measurement cycle. For example, the plot as indicated by the third image 174 in the third window 172 may be updated via the processor 110 based on sound pressure driving the vibration of the structure at a subsequent plurality of frequencies, as indicated by lines 220 232 234 236 in a subsequent measurement cycle.

Various embodiments may be implemented, for example, using one or more well-known computer systems, such as computer system 500 shown in FIG. 5. For example, the handheld vibrometry system 120 may be implemented using combinations or sub-combinations of computer system 500. Also, or alternatively, one or more computer systems 500 may be used, for example, to implement any of the embodiments discussed herein, as well as combinations and sub-combinations thereof.

FIG. 5 shows a computing device 500 for implementing various embodiments, according to some embodiments. For example, computing device 500 may function as system of the handheld vibrometry system 120 or any portion(s) thereof, or multiple computing devices 500 may function as a system of the handheld vibrometry system 120.

Computing device 500 may be implemented on any electronic device that runs software applications derived from compiled instructions, including without limitation personal computers, servers, smart phones, media players, electronic tablets, game consoles, email devices, or the like. In some implementations, computing device 500 may include one or more processors 110, one or more input devices 504, one or more display devices 506, one or more communication interfaces 508, and one or more computer-readable medium 510. Each of these components may be coupled by bus 518, and in some embodiments, these components may be distributed among multiple physical locations and coupled by a network.

Control unit 540 may assist in controlling the handheld vibrometry system 120. The control unit 540 may send an electronic control signal to components of the handheld vibrometry system 120.

Display device 506 may be any known display technology, including but not limited to display devices using Liquid Crystal Display (LCD) or Light Emitting Diode (LED) technology. Processor(s) 110 may use any known processor technology, including but not limited to graphics processors and multi-core processors. Input device 504 may be any known input device technology, including but not limited to a keyboard (including a virtual keyboard), mouse, controller, joystick, track ball, and touch-sensitive pad or display.

Bus 518 may be any known internal or external bus technology, including but not limited to ISA, EISA, PCI, PCI Express, NuBus, USB, Serial ATA or FireWire. In some embodiments, some or all devices shown as coupled by bus 518 may not be coupled to one another by a physical bus, but by a network connection, for example. Computer-readable medium 510 may be any medium that participates in providing instructions to processor(s) 110 for execution, including without limitation, non-volatile storage media (e.g., optical disks, magnetic disks, flash drives, or the like), or volatile media (e.g., SDRAM, ROM, or the like).

Computer-readable medium 510 may include various instructions for implementing an operating system 512 (e.g., Mac OS, Windows, Linux). The operating system 512 may be multi-user, multiprocessing, multitasking, multithreading, real-time, and the like. The operating system 512 may perform basic tasks, including but not limited to: recognizing input from input device 504; sending output to display device 506; keeping track of files and directories on computer-readable medium 510; controlling peripheral devices (e.g., disk drives, printers, or the like) which may be controlled directly or through an I/O controller; and managing traffic on bus 518. Network communication 514 may establish and maintain network connections (e.g., software for implementing communication protocols, such as TCP/IP, HTTP, Ethernet, telephony, or the like).

Application(s) and program module(s) 516 may be an application that uses or implements the outcome of processes described herein and/or other processes. For example, application(s) 516 may provide UI and/or UI elements for displaying and/or manipulating updates identified by computer device 500 as described above. In some embodiments, the various processes may also be implemented in operating system 512.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors 110 for the execution of a program of instructions may include, by way of example, both general and special purpose microprocessors, and the sole processor or one of multiple processors or cores, of any kind of computer. Generally, a processor 110 may receive instructions and data from a read-only memory or a random-access memory or both. The essential elements of a computer may include a processor 110 for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication network include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs may include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, or the like.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, or the like, using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for displaying a plurality of measurement cycles at a plurality of frequencies in a graphical user interface (GUI) comprising:
generating, via a processor, a first image comprising a structure based on at least one signal, wherein the at least one signal comprises a vibrometry measurement of a vibration of the structure;
displaying, via the processor, a first window within the GUI comprising the first image;
generating, via the processor, a second image comprising a real time image of the structure;
displaying, via the processor, a second window within the GUI comprising the second image;
determining, via the processor, a plurality of mobility measurements at the plurality of frequencies for at least one of the plurality of measurement cycles, wherein each of the plurality of the mobility measurements are based on an amplitude of the vibration induced at the structure and sound pressure driving the vibration of the structure at each of the plurality of frequencies;
displaying, via the processor, a third window within the GUI comprising a plot of at least of the plurality of mobility measurements at the plurality of frequencies; and
updating, via the processor, the plot based on sound pressure driving the vibration of the structure at a subsequent measurement cycle.

2. The computer-implemented method of claim 1, wherein the first image comprises a region with vibration displacement amplitudes.

3. The computer-implemented method of claim 2, wherein the first image is a 2D, 3D, or 4D image.

4. The computer-implemented method of claim 2, wherein the region is designated by a graphic overlay in the first image.

5. The computer-implemented method of claim 1, wherein the first image is a B-mode image comprising a graphic overlay.

6. The computer-implemented method of claim 1, wherein the real time image is a camera image.

7. The computer-implemented method of claim 1, wherein the plurality of frequencies is emitted separately and are between 125 and 8000 Hz.

8. The computer-implemented method of claim 1, wherein the structure is an ossicle of the middle ear.

9. A system for displaying a plurality of measurement cycles at a plurality of frequencies in a graphical user interface (GUI) comprising:
one or more memories; and
at least one processor each couple to at least one of the memories and configured to perform operations comprising:
generate a first image comprising a structure based on at least one signal, wherein the at least one signal comprises a vibrometry measurement of a vibration of the structure;
display a first window within the GUI comprising the first image;
generate a second image comprising a real time image of the structure;
display a second window within the GUI comprising the second image;
determine a plurality of mobility measurements at the plurality of frequencies for at least one of the plurality of measurement cycles, wherein each of the plurality of the mobility measurements are based on an amplitude of the vibration induced at the structure and sound pressure driving the vibration of the structure at each of the plurality of frequencies;
display a plot of at least of the plurality of mobility measurements at the plurality of frequencies; and
update the plot based on sound pressure driving the vibration of the structure at a subsequent measurement cycle.

10. The system of claim 9, wherein the first image comprises a region with vibration displacement amplitudes and wherein the first image is a 2D, 3D, or 4D image.

11. The system of claim 10, wherein the region is designated by a graphic overlay in the first image.

12. The system of claim 9, wherein the first image is a B-mode image a graphic overlay.

13. The system of claim 9, wherein the plurality of frequencies is emitted separately and are between 125 and 8000 Hz.

14. The system of claim 9, wherein the structure is an ossicle of the middle ear.

15. A non-transitory computer-readable medium having instructions stored thereon that, when executed by at least one computing device, cause the at least one computing device to perform operations comprising:
generating a first image comprising a structure based on at least one signal, wherein the at least one signal comprises a vibrometry measurement of a vibration of the structure;
displaying a first window within a graphical user interface (GUI) comprising the first image;
generating a second image comprising a real time image of the structure;
displaying a second window within the GUI comprising the second image;
determining a plurality of mobility measurements at a plurality of frequencies for at least one of a plurality of measurement cycles, wherein each of the plurality of mobility measurement is based on an amplitude of the vibration of the structure and sound pressure driving the vibration induced at the structure at each of the plurality of frequencies;
displaying a third window within the GUI comprising a plot of at least of the plurality of mobility measurements at the plurality of frequencies; and
updating the plot based on sound pressure driving the vibration of the structure at a subsequent measurement cycle.

16. The non-transitory computer-readable medium of claim 15, wherein the first image comprises a region with vibration displacement amplitudes and wherein the first image is a 2D, 3D, or 4D image.

17. The non-transitory computer-readable medium of claim 16, wherein the region is designated by a graphic overlay in the first image.

18. The non-transitory computer-readable medium of claim 15, wherein the first image is a B-mode image comprising a graphic overlay.

19. The non-transitory computer-readable medium of claim 15, wherein the plurality of frequencies is emitted separately and are between 125 and 8000 Hz.

20. The non-transitory computer-readable medium of claim 15, wherein the structure is an ossicle of the middle ear.
